(19) United States
(12) Patent Application Publication
(10) Pub. No.: US 2002/0091627 A9
(43) Pub. Date: Jul. 11, 2002

(54) Running exerciser structure

(76) Inventor: Chia-Feng Yang, Chia-Li Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/737,746

(22) Filed: Dec. 18, 2000

(30) Foreign Application Priority Data
Dec. 21, 1999 (TW) 88221960

(51) Int. Cl. G06F 17/60

(52) U.S. Cl. 705/38

(57) ABSTRACT

Running exerciser structure including a base seat, a running belt, a driving unit and a handle section. The base seat has a pair of substantially parallel frame bodies. A compound supporting board is disposed between the frame bodies. The compound supporting board includes a polished top board made of stainless steel and a sound-absorbent section. The polished top board is not subject to wearing and rusting caused by the sweat of a user so that the frictional resistance against the running belt is reduced. Also, the noise produced during running can be absorbed by the sound-absorbent section and is greatly lowered. The running exerciser can be durably used without frequently replacing the supporting board and the running belt.

### BACKGROUND OF THE INVENTION

The present invention is related to a running exerciser structure, and more particularly to a running exerciser in which the running board is a compound supporting board including a polished top board made of stainless steel and a sound-absorbent section. Therefore, the running board is not subject to wearing and rusting to reduce frictional resistance and the noise produced during running can be greatly lowered.

FIGS. 1 to 5 show a conventional running exerciser including:

a base seat 1 having a pair of substantially parallel frame bodies 11, a first and a second roller shafts 12, 13 being pivotally disposed between the frame bodies 11 respectively near two ends thereof;

a running belt 2 which is circularly rotatable for a user to run and exercise thereon, the running belt 2 being wound around the first and second roller shafts 12, 13 to define an upper and a lower belt sections 21, 22;

a driving unit 3 disposed inside or outside the base seat 1 for driving the first roller shaft 12 or the second roller shaft 13 or both, whereby the running belt 2 can circularly rotate by a predetermined speed; and

a handle section 4 upward extending from the base seat 1.

A supporting board 14 is disposed between the first and second roller shafts 12, 13. The supporting board 14 is generally made of wooden or iron material. The surface of the wooden supporting board 14 must be polished to reduce frictional force. With respect to the iron-made one, the surface must be plated (or coated or sprayed) with a layer of protective film for avoiding rusting caused by the sweat of the user and reducing frictional resistance.

However, the wooden supporting board 14 has some shortcomings as follows:

1. Insufficient strength and flexibility. The plywood-made supporting board has poor strength and flexibility. Such supporting board is subject to cracking and can hardly bear reciprocal application force. In the case that the user has a big body (for example, over 100 kilograms), during running, the wooden supporting board may be trodden and cracked apart. This is extremely dangerous. To solve this problem, the wooden supporting board at least must have a thickness of ½ inch (1.27 cm). This makes the supporting board quite heavy.

2. Subject to change of temperature, humidity and salt. When the products are exported to other countries with different weathers, it often takes place that the wooden supporting board is deformed due to great change of temperature and humidity (thermal contraction/expansion). Also, when shipped, the great change of temperature in day and at night and the high content of salt will deform the wooden supporting board or deteriorate the strength of the wooden supporting board. This often results in safety problem.

The iron-made supporting board 14 has some shortcomings as follows:

1. The surface is liable to be worn out and rusted by the sweat of the user. After a period of use, the polished upper protective surface of the supporting board 14 will be worn out by the running belt 2. Under such circumstance, the salted sweat of the user dropping onto the surface will speed the rusting of the surface. This increases the frictional resistance against the running belt 2. As a result, the running belt 2 will be worn out soon and need to be replaced in short time.

2. When the user runs on the running belt 2 and repeatedly treads the supporting board 14, the supporting board 14 will be slightly bent and then restored into a straight state. During such procedure, a noise is continuously produced to bother the user and the others.

### SUMMARY OF THE INVENTION

It is therefore a primary object of the present invention to provide an improved running exerciser structure including a compound supporting board which is not subject to wearing and rusting caused by the sweat of a user so that the frictional resistance against the running belt is reduced. Therefore, the running exerciser can be durably used without frequently replacing the supporting board and the running belt.

It is a further object of the present invention to provide the above running exerciser in which the compound supporting board includes a sound-absorbent section for absorbing and greatly lowering the noise produced during running.

The present invention can be best understood through the following description and accompanying drawings wherein:

### BRIEF DESCRIPTION OF THE DRAWINGS

FIG. 1 is a perspective view of a conventional running exerciser;

FIG. 2 is a sectional view of the conventional running exerciser;

FIG. 3 is a sectional view of the roller shaft of the conventional running exerciser;

FIG. 4 is a sectional view of the supporting board of the conventional running exerciser;

FIG. 5 is a sectional view of the running belt of the conventional running exerciser;

FIG. 6 is a perspective view of the present invention;

FIG. 7 is a partially sectional perspective view of a part of the present invention;

FIG. 8 is a sectional view of a part of the present invention; and

FIG. 9 is a partially sectional view of a part of another embodiment of the present invention.

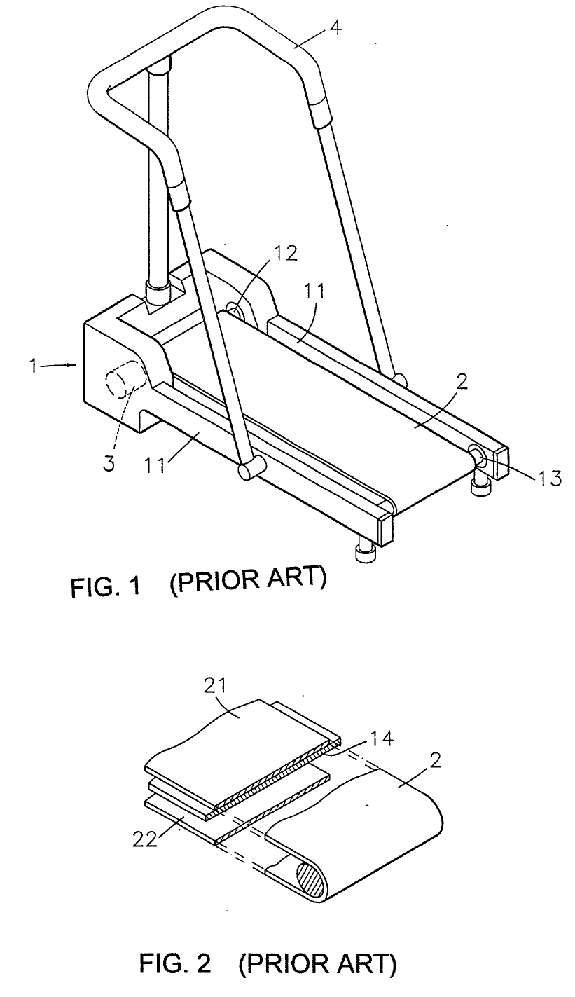

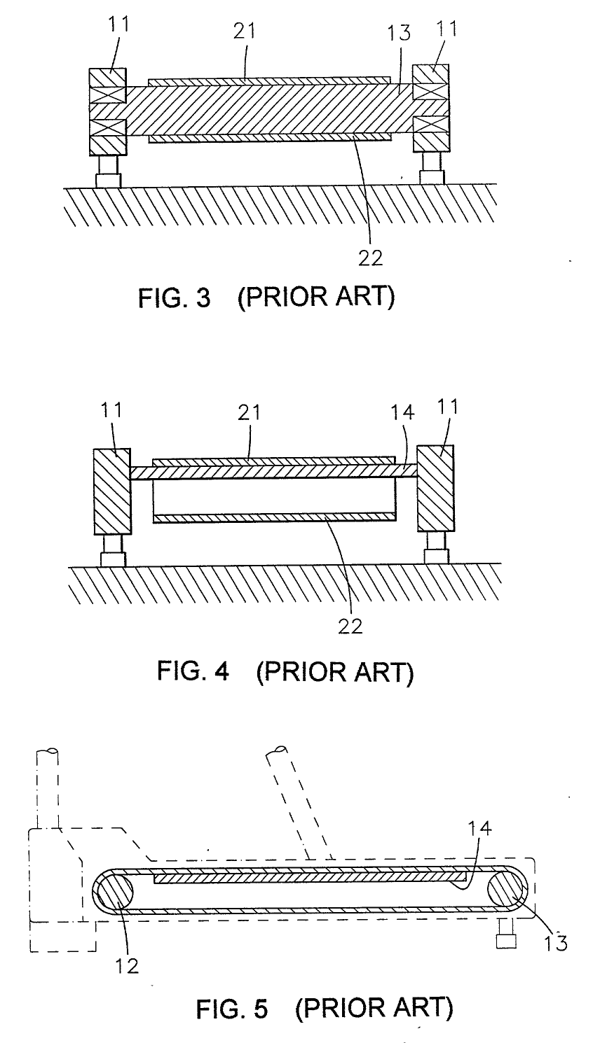

### DETAILED DESCRIPTION OF THE PREFERRED EMBODIMENTS

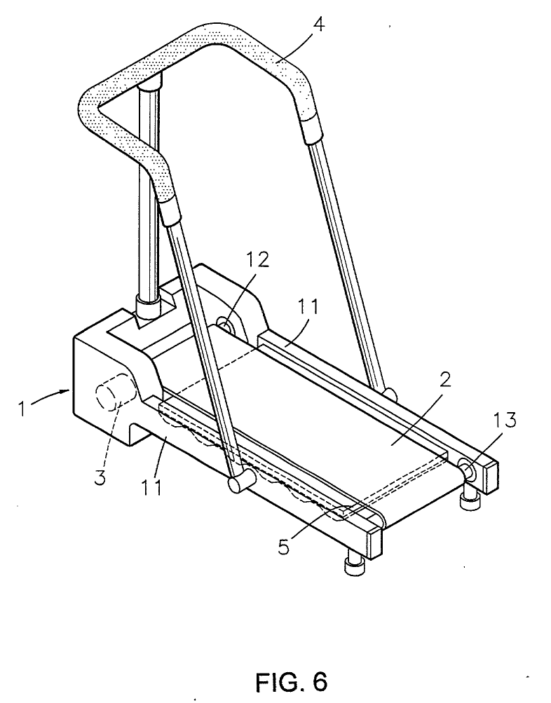

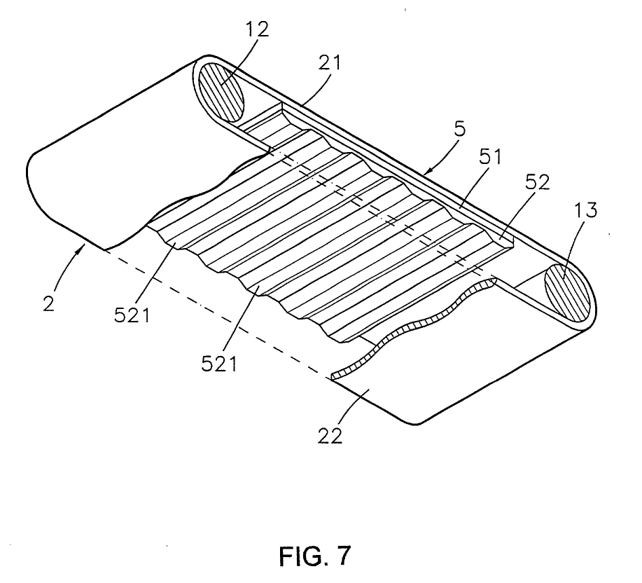

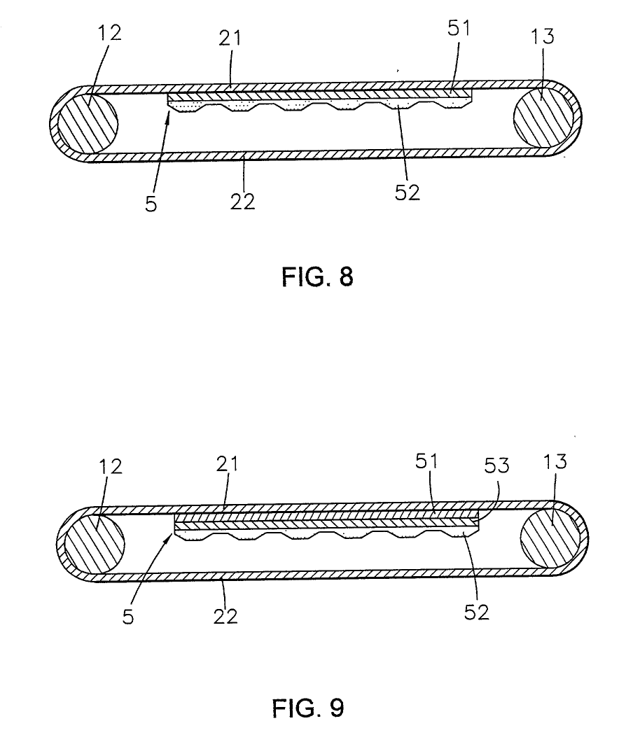

Please refer to FIGS. 6 to 8. The running exerciser of the present invention includes abase seat 1, a running belt 2, a driving unit 3 and a handle section 4.

The base seat 1 has a pair of substantially parallel frame bodies 11. A first and a second roller shafts 12, 13 are pivotally disposed between the frame bodies 11 respectively near two ends thereof.

The running belt 2 is circularly rotatable for a user to run and exercise thereon. The running belt 2 is wound around the first and second roller shafts 12, 13 to define an upper and a lower belt sections 21, 22.

The driving unit 3 is disposed inside or outside the base seat i1 for driving the first roller shaft 12 or the second roller shaft 13 or both, whereby the running belt 2 can circularly rotate by a predetermined speed. The driving unit 3 also can be replaced by a conventional inertial flywheel system (not shown) driven by feet.

The handle section 4 upward extends from the base seat 1. A controlling unit (not shown) can be disposed on the handle section 4, such as a speedometer, odometer, etc.

A compound supporting board 5 is disposed between the first and second roller shafts 12, 13 at the center of the parallel frame bodies 11. The compound supporting board 5 includes a polished top board 51 made of stainless steel and a sound-absorbent section 52 made of plastic, foam, synthetic or rubber material.

The polished top board 51 is designed with a thickness according to the weight of the load. The top board 51 forms a sliding frictional contact face against the upper belt section 21 of the running belt 2. The polished top board 51 is made of stainless steel so that when the sweat of the user drops onto the polished top board 51, the top board 51 is free from the problem of rusting. Therefore, the frictional resistance will not increase and the strength of the supporting board 5 will not be deteriorated.

The sound-absorbent section 52 is made of plastic, foam, synthetic or rubber material serves to effectively absorb the noise produced when the polished top board 51 is repeatedly trodden and deformed and restored to its original state. Accordingly, the bothering noise during running can be greatly reduced. The shape of the sound-absorbent section 52 is not limited. One design thereof has multiple parallel ribs 521 for enhancing the sound-absorbing effect. Alternatively, there are multiple sound-absorbent sections (not shown) spaced from each other and fixed under the lower surface of the polished top board 51 by an adhesive or screws.

FIG. 9 shows another embodiment of the present invention, in which one or more layers of hard intermediate boards 53 made of low cost material (such as wooden board or reinforced plastic board) can be sandwiched between the polished top board 51 and the sound-absorbent section 52. Accordingly, the compound supporting board 5 still has sufficient strength and the same function, while being manufactured at lower cost.

The above embodiments are only used to illustrate the present invention, not intended to limit the scope thereof. Many modifications of the above embodiments can be made without departing from the spirit of the present invention.

What is claimed is:

1. Running exerciser structure comprising:
a base seat having a pair of substantially parallel frame bodies, a first and a second roller shafts being pivotally disposed between the frame bodies respectively near two ends thereof;
a running belt which is circularly rotatable for a user to run thereon, the running belt being wound around the first and second roller shafts to define an upper and a lower belt sections;
a driving unit disposed inside or outside the base seat for driving the first roller shaft or the second roller shaft or both, so that the running belt can circularly rotate by a predetermined speed; and
a handle section upward extending from the base seat;
wherein a compound supporting board is disposed between the first and second roller shafts at the center of the parallel frame bodies, the compound supporting board including a polished top board made of stainless steel and a sound-absorbent section, the compound top board forming a sliding frictional contact face against the upper belt section of the running belt, the sound-absorbent section serving to effectively absorb the noise produced when the polished top board is repeatedly trodden and deformed and restored to its original state.

2. Running exerciser structure as claimed in claim 1, wherein the sound-absorbent section has multiple parallel ribs.

3. Running exerciser structure as claimed in claim 1, wherein there are multiple sound-absorbent sections spaced from each other and fixed under the lower surface of the polished top board by an adhesive or screws.

4. Running exerciser structure as claimed in claim 1, wherein one or more layers of intermediate boards are sandwiched between the polished top board and the sound-absorbent section.

5. Running exerciser structure as claimed in claim 1, wherein the sound-absorbent section is made of plastic, foam, synthetic or rubber material.
